(19) United States
(12) Patent Application Publication
(10) Pub. No.: US 2014/0200137 A1
(43) Pub. Date: Jul. 17, 2014

(54) TREATMENT OF STORED TUBERS WITH COMPOSITIONS OF ALKYL NAPHTHALENES AND HIGHER ALCOHOLS

(71) Applicant: 1,4 Group, Inc., Meridian, ID (US)

(72) Inventors: John M. Forsythe, Nampa, ID (US); James Zalewski, Boise, ID (US); Curtis Lee Eames, Meridian, ID (US); Addie Waxman, Meridian, ID (US); Henry John Duncan, Glasgow (GB)

(21) Appl. No.: 14/154,489

(22) Filed: Jan. 14, 2014

Related U.S. Application Data
(60) Provisional application No. 61/753,249, filed on Jan. 16, 2013.

(51) Int. Cl. A01N 31/02; A01N 27/00

(52) U.S. Cl. CPC A01N 31/02; A01N 27/00
USPC 504/118

(57) ABSTRACT

A method and composition of treating post-harvest tubers with a higher alcohol and a lower alkyl naphthalene to suppress sprouting.

### CROSS-REFERENCE TO RELATED APPLICATION

This application claims the benefit of U.S. Provisional Patent Application Ser. No. 61/753,249, filed Jan. 16, 2013, the disclosure of which is hereby incorporated herein in its entirety by this reference.

### TECHNICAL FIELD

This invention relates generally to chemical compositions and processes useful to treat crops, especially tubers, during post-harvest, in storage, and in transit, to consumers or to processing facilities.

### BACKGROUND OF INVENTION

Many crops, such as potatoes, onions and other tubers and bulbs, are stored for an extended period after harvest. These crops are treated with pesticides, fungicides, and herbicides of a nature which prevent sprouting of the crop during storage. This is especially true for tubers, such as potatoes.

The principal herbicide, CIPC (chlorpropham or chloro-isopropylcarbamate), has been used for decades as a sprout inhibitor for potatoes. While it is effective, it is receiving increased scrutiny from the US EPA and the UK EU Chemical Safety Commissions, which have been limiting the dosages that may be applied. CIPC acts as a mitosis inhibitor in suppressing sprouting. It is applied as an aerosol generally before the stored potato pile has settled before dormancy has ended, i.e., typically before any sprouting has occurred.

U.S. Pat. Nos. 5,935,660 and 6,068,888 to Forsythe et al., describe a current technique for thermofogging solid CIPC to provide an effective, stable aerosol.

More recently, 1,4 dimethyl naphthalene has been used effectively as a dormancy enhancer/sprout inhibitor for potatoes. Its action is hormonal in nature. This chemical also helps the potatoes stay turgid (hydrated). It is available from 1,4 Group, Meridian, Idaho as 1,4 Sight®.

Numerous patents have issued relative to the use of 1,4-DMN, such as U.S. Pat. No. 5,918,537, U.S. Pat. No. 5,965,489, U.S. Pat. No. 6,010,728, U.S. Pat. No. 6,310,004, U.S. Pat. No. 6,375,999, and U.S. Pat. No. 6,403,536.

Stored tubers, such as potatoes, tend to sprout during storage. Distributors and grocers providing fresh-pack potatoes to consumers desire such potatoes to show no evidence of peeps or sprouts. Various techniques, such as the use of clove oil or CIPC late in the storage season or during processing of potatoes in packing sheds, have been used to “burn” any peeps or sprouts present.

Clove oil, which has also been used to burn sprouts on stored potatoes, has an objectionable odor, making its use objectionable by some. Use of CIPC is not desirable on potatoes to be consumed without being washed or processed into products, such as french fries. A principal drawback to 1,4-DMN is its cost and the fact that it is volatile and tends to diffuse from treated potatoes over a length of time. It has been used commercially in accordance with the above listed patents.

Lower alcohols, such as methanol, isopropanol and the like, are good solvents for CIPC and could, perhaps, contribute to sprout inhibition. However, CIPC solutions, when applied to stored potatoes as an aerosol, via thermofoggers, are subjected to very high temperatures (e.g., 700° F. and above), which temperatures tend to decompose lower molecular weight alcohols, especially methanol, creating toxic decomposition products. Methanol itself is toxic and its decomposition products, such as formaldehyde, are toxic, are not useful sprout inhibitors, and are generally considered undesirable as a residue on potatoes.

Higher alcohols, such as C₆-C₁₂ alcohols, are less volatile than lower molecular weight alcohols. However, the flesh damaging characteristics of these alcohols reported in prior literature have generally precluded their adoption as commercial sprout inhibitors for potatoes.

During the 1950's, especially in the U.K., considerable experimentation, and even commercial treatment occurred with higher alcohols, especially alkyl alcohol and nonanol. In Nature, vol. 178, p. 218 (Jul. 28, 1956) Burton tested alcohols of C₁ to C₁₀ carbon chain length. Best results were achieved with amyl and nonyl alcohols. Worst results were for n-hexyl and 2-ethyl-hexan-1-01, an octyl alcohol. Later, in his book “The Potato” (1966), Burton summarizes work with nonanol (3,5,5-trimethyl-Laxan-1-01) vapor at pages 285 and 286. There, he comments that high initial concentrations would be toxic to the tubers. His treatments were for equal periods of two weeks on and two weeks off until the potatoes are removed from store. He states a consumption of nonanol of about 300 g per 1000 kg (300 ppm) potatoes for every month of storage. He further notes that the killed sprouts may die back into the tuber flesh, with resultant blemishes and possibly rotting if sprouting has become well advanced before application of nonanol.

Even higher molecular weight aldehydes and ketones, such as certain ∝, β-unsaturated alphatic compounds identified by Knowles et al. (U.S. Pat. No. 6,855,669), showed pitting of the potato. See Knowles patent, Example 4, col. 11, lines 50 et seq. It may further be noted that preferred compounds advanced by Knowles et al. are effective as sprout inhibitors only at very high dosages 9 e.g., in excess of 70 ppm) and that numerous treatments per storage season would be required to maintain stored potatoes in a sprout free condition. The preferred aldehydes identified by Knowles et al. have a chemical structure nearly identical with citral, a known sprout inhibitor, which is known to be effective only at high dosages. A similar preference for alkenyl compounds is described in U.S. Pat. No. 3,159,476 wherein an octenyl alcohol mixture is shown to be superior to an isooctyl alcohol as a sprout inhibitor for potatoes. This 1964 patent is in the same timeframe as Burton's work when various types of alcohols were being tested and then later abandoned for commercial purposes for a wide variety of reasons. No notation is made in the U.S. Pat. No. 3,159,476 as to whether there was pitting of the potatoes. Also, it is not stated whether the potatoes were in a dormant state when the treatments were commenced. The 25° C. storage temperature (˜78° F.) used is not a commercial storage temperature for potatoes (Ex. I-III) nor is 15° C. (˜59° F.) in Ex. IV-VI.

### SUMMARY OF THE INVENTION

A process for suppressing sprouting of post-harvest potatoes includes: treating the potatoes with a C₅-C₁₂ carbon alkyl alcohol, aldehyde, or ketone compound, or lower alkyl esters of said C₅-C₁₂ carbon alkyl alcohols; and treating of the potatoes with a lower alkyl naphthalene compound so that both compounds are in the presence of the stored potatoes at substantially the same time.

A composition for treatment of post-harvest potatoes to suppress sprouting includes: a C₅-C₁₂ carbon compound selected from the group consisting of alkyl and alkenyl alcohols, aldehydes, and ketones; and a lower alkyl naphthalene.

A method of desiccating existing sprouts on post harvest potatoes includes applying a thermofogged aerosol of a C₅-C₁₂ alkyl alcohol and lower alkyl naphthalene for a sufficient period of time to provide a concentration of said aerosol in the atmosphere surrounding said potatoes effective to desiccate any sprouts and/or peeps present upon said potatoes.

A method of treating post-harvest tubers with a composition of a C₅-C₁₀ alkyl alcohol and 1,4-DMN by thermofogging said composition at a temperature at about 300° F. to about 650° F.

### DETAILED DESCRIPTION OF THE INVENTION

It has been discovered that higher alcohols having C₅-C₁₂ alkyl and alkenyl carbon chains, whether linear chains or branched chains, can be effectively applied as a sprout suppressant via thermoaerosol generation in combination with a lower alkyl naphthalene without adverse results, such as pitting in or near potato eyes. The technique generally employs the compositions of such alcohols and alkyl naphthalenes at a low dosage per unit weight of potatoes being treated. Also, the aerosols are preferably applied to potatoes after “peeps” (nascent sprouts) or sprouts have developed. Depending upon other factors, this may be an advantage to a grower, who can defer treatment until after peeps or sprouts occur, thereby minimizing or altogether eliminating the cost of other sprout control treatments, depending upon the inherent dormancy period of that batch of potatoes and the timing of their sale/use.

Higher alcohols, such as C₆-C₁₂ alphatic alcohols, applied as a thermofogged aerosol are especially effective sprout inhibitors for stored potatoes in combination with lower alkyl naphthalenes, which tends to ameliorate any damaging effect to tuber flesh while enhancing the sprout “burning” (desiccating) effect of the alcohol component. This combination may be applied as a solution of a higher alcohol and a lower alkyl naphthalene, or the two compounds may be separately applied in a sequential technique. Alcohols of a chain length greater than 9 carbon atoms are generally solid at room temperature, but may be dissolved in a suitable solvent, including lower alkyl naphthalenes, such as 1,4 dimethyl naphthalene (1,4-DMN). If fogged or aerosolized, these alcohols may be introduced to the fogger in a molten form in the manner now commonly practiced with pure, solid CIPC.

One aspect of the instant invention is the aerosolization of higher alcohols at appropriate temperatures and rates of application to control dosage and treatment time, whether such alcohols are thermofogged alone or as conjunction with other chemicals. Thermofogging of higher alcohols at temperatures generally not exceeding about 650° F., and preferably at temperatures below about 550° F., produced a stable aerosol which was efficiently dispersed throughout a potato storage facility by its internal circulation system. Temperature measurements can be taken at a nozzle exit point. It is understood that temperatures higher than 650° F. can be used, particularly where a higher concentration of DMN is utilized in combination with the higher alcohols. Thermofogging allows a rapid treatment to reach a much higher, short-term, acute concentration (compared to wicking and chronic treatment), thereby achieving an instantaneous burning of exposed sprout tissue while avoiding the longer term exposure of eyes or skin to such high levels that result in damage or injury to said tissue. Alcohols, such as various isomers of nonanol and hexanol, for example, are sufficiently volatile that the most direct way to apply them to stored potatoes per Burton's treatment was by wicking, especially since these alcohols also have a relatively low ignition temperature which would contraindicate a thermofogging technique.

Many higher alcohols are included on the GRAS (Generally Regarded as Safe) list, making them especially useful for treatment of a food product. Some lower alkyl naphthalenes, such as 1,4 dimethyl naphthalene and dissopropyl naphthalene are registered in the USA as permissible sprout suppressants. Thus, alcohols identified on the GRAS list may be applied alone or in conjunction with another chemical which is registered with the EPA as approved for use in fresh-pack potatoes. For example, useful in this regard is 1-octanol, which is on the GRAS list and also on an exempt list as a food additive.

A significant advantage of 1,4-DMN is its ability to preserve tuber hydration, an important aspect for stored tubers. This characteristic of 1,4-DMN makes it an effective conjunctive to incorporate with higher alcohols in diminishing damage to a tuber while improving the desiccating effect upon tuber eyes, peeps, and sprouts. Although the enhancement of the desiccating effect by 1,4-DMN is not fully understood, the presence of 1,4-DMN may make potato peeps and sprouts more receptive to the alcohol vapor. The exact nature of the advantageous interaction of these two types of chemicals is not fully understood.

The effective cooperative assistance of 1,4-DMN with higher alcohols can be an admixture of the two or a sequential treatment of each closely timed so that the two chemicals are in the presence of the tubers at about the same time. A solution can be readily formed with higher alcohols in 1,4-DMN. Treatment with 1,4-DMN has been shown to maintain said treated potatoes in a highly hydrated state even after a residue of the chemical is no longer detectable so that a sequential treatment having a time delay of many weeks between an initial application of DMN and later treatment with a higher alcohol still provides beneficial results.

The ratio of lower alkyl naphthalene to higher alcohol may vary over a wide range depending upon a number of factors, such as the health and hydration of the stored tubers, the degree of peeps or sprouting present, and the presence or absence of other sprout suppressants (e.g., CIPC) on the stored tubers, the remaining duration of storage, and the storage condition (such as temperature and humidity). Given that 1,4-DMN and C₅-C₁₀ alcohols are liquids at room temperature, volumetric ratios of 1:20 to about 20:1 can be prepared. Such admixtures also can be prepared at ratios of about 1:1, ratios of about 10:1 to 1:10, and ratios of about 5:1 to about 1:5.

In the preparation of compositions containing both lower alkyl naphthalenes and higher alcohols, other chemicals (e.g., diluents, fungicides, bactericides, and/or herbicides), may be present along with other sprout suppressants such as CIPC. Both 1,4-DMN and higher alcohols are effective solvents for each other and for CIPC, the most common commercial sprout suppressant in current use. The mode of action of CIPC as a mitosis inhibitor is different from that of 1,4-DMN, for example, and from that of higher alcohols. The action of 1,4-DMN, in particular, has been shown to activate genes within a potato associated with plant growth regulation while higher alcohols, as stated above, are strong desiccants.

### EXAMPLE I

Liquid 1-nonanol was fed to a thermofogger set to operate at an aerosolization temperature of about 550° F. The temperature quickly increased to about 750° F., indicating that the nonanol was combusting.

### EXAMPLE II

Stored potatoes in bulk storage were treated with 1-nonanol (n-nonyl alcohol) via a thermofogger to determine sprout inhibition. The thermofogger was operated at an aerosol chamber temperature of about 500° F. A good stable aerosol was produced. The alcohol was applied at a dosage of 8 ml for 2 kg of potatoes. The system was open so that the actual dosage reaching the potatoes was considerably less than the fogged amount.

In a first bulk storage, the potatoes had white “peeps” showing from the eyes. These peeps were burned to a dark color and were inactivated without any damage to potato flesh located adjacent the eyes.

### EXAMPLE III

In another test, the potatoes were treated with 1-nonanol at the same fogging temperature and dosage for the same period of time to achieve the same application dosage as in Example II. The potatoes in this storage had sprouts averaging in excess of about 2 cm in length. In this experiment, potatoes with very long sprouts, some up to 8 cm or more, were treated 1, 2, and 4 times sequentially with full strength nonanol. This “spray-paint” method was used to try to bring the total amount (rate) of nonanol up to a level capable of killing large sprouts as well as peeps . . . a necessity in commercial settings where sprouts of all sizes exist. Four applications reached the level at which these large sprouts were completely killed. The negative side effect observed was a wet, slimy, sprout rot, which dampened but did not otherwise rot the tuber skin or tissue that came in contact with these sprouts. While this was a small scale test, a whole storage full of potatoes in this condition would likely lead to secondary decays. Single or even double applications didn't reach a level of nonanol high enough to completely kill these sized sprouts.

### EXAMPLE IV

The results of Example III led to another experiment where nonanol and DMN were applied. Single applications of 1:1 nonanol and DMN completely killed large sprouts without producing the wet, slimy phase observed in Example III, but rather resulted in a faster, drier, sprout kill which avoids these conditions that could potentially lead to secondary infection. This example showed the following: 1) nonanol and DMN combinations are much more effective than nonanol alone; and 2) the same combination appears to kill and desiccate sprouts much more rapidly, resulting in dry, brittle, rather than wet, slimy sprout remnants, thereby avoiding conditions that could lead to secondary decay problems.

### EXAMPLE V

Treatment via fogging at an appropriate temperature showed 1-nonanol to be about four times as effective as clove oil in “burning” peeps and sprouts when applied at similar dosages.

### EXAMPLE VI

An aerosol of 50/50 volumetric rates of DMN and 1-hexanol formed by thermofogging at about 450° F. was applied to potatoes with “peeps” showing. The “burn” of the peeps was complete and the potatoes had a shelf life of about 30 days without any further “peeps” or sprouts evident.

After washing, the floral odor of 1-nonanol treated potatoes is greatly diminished, and also given its volatility, by the time such potatoes reach the grocers shelves, no significant odor is detectable.

### EXAMPLE VII

Various sprout suppressing chemicals were compared for their ability to suppress existing sprouts on post-dormant potatoes with peeps and sprouts extant. All chemicals were applied via a thermofogging technique at comparable dosages. The results are set forth in the following table.

| Chemical | Burn “old” | Burn “new” | Smell | Comments |
|---|---|---|---|---|
| Clove oil | ++ | ++ | Strong clove | |
| 1-Nonanol | +++ | +++ | Moderate | |
| Oregano oil | ++ | ++ | Strong spice | |
| AmylAcetate | na | ++ | Rotten banana | |
| Hexanol | + | ++ | Pleasant, fruity | |
| Dodecanol | −\+ | − | moderate | Stringy, sticky |
| Dipropylene | −\+ | − | moderate | |
| Glycol | | | | |
| 1,4-DMN | + | + | moderate | Enhances all |
| | | | | burn products; |
| | | | | appears critical |
| | | | | in rescue |
| | | | | treatments |
| 1-Octanol | ++ | +++ | pleasant | |
| 1-Decanol | ++ | ++ | moderate | |

In the above table the explanation of the designation is as follows:

+—indicates fair effectiveness

++—indicates good effectiveness

+++—indicates excellent effectiveness

A minus (−) sign indicates no noticeable effect while a +/− sign indicates only partial effectiveness at a minimal level.

In the above table “Burn old” refers to the effect upon old sprouts, which included sprouts up to nine months old, these being generally more difficult to desiccate, while “burn new” refers to newly emerged sprouts and peeps, generally less than a month or so in existence.

Clove oil contains active ingredients eugenol and isoeugenol; cyclical organic phenols. Oregano oil is composed of carvacol, thymol, limonene, pinene, ocimene and carophyllene. Eugenol, isoeugenol, carvacol and thymol, all phenol-type compounds, are also characterized as monoterpenes.

The chemical which performed best in this test was 1-nonanol. It most effectively desiccated existing peeps and sprouts and was noticeably better than clove oil, which has been used commercially for this purpose for about a decade. Also, 1-nonanol has a less objectionable odor than clove oil.

The very best results of any of the alcohols are in combination with 1,4-DMN. The exact nature of the interaction is not currently understood.

### EXAMPLE VIII

Mixtures of 1,4-DMN with octanol in the following ratios provide results as set forth in the following Table.

Octanol to 1,4-DMN—Volumetric Ratio

| | Rapid Burn | Length of Burn |
|---|---|---|
| 1:7 | +++ | +++ |
| 1:3 | +++ | +++ |
| 1:1 | +++ | +++ |
| 3:1 | +++ | +++ |
| 7:1 | +++ | +++ |
| 1:0 | ++ | +++ |

Total dosage of each mixture was constant.
+++ Excellent effect
++ Very good effect
+ Good effect
— Negligible effect

All mixtures provided a more rapid burn of sprouts compared with an equal dosage of octanol or 1,4-DMN alone. The 7:1 ratio of octanol to DMN gave the best results in terms of length of non-sprouting condition before nascent sprouts again appeared.

One of the short comings of higher alcohols has been pitting of periderm adjacent to sprouts. This was reported by Burton with the use of nonanol. Burton in his textbook cautioned that high concentration of nonanol could be toxic. Knowles also observed pitting.

### EXAMPLE IX

An experiment was performed wherein 1-octanol at various dosages were applied to potatoes where the temperature of the potatoes was at about 36° F. The 1-octanol was applied via an electrically treated thermofogger at a fog temperature within the fogger of about 500° F. to obtain a stable aerosol. The potatoes were examined about 24 hours after treatment. Evidence was apparent that the alcohol had condensed upon the skin of the potatoes, leaving large dark damaged spots.

The potatoes were cut open at the dark spots. Damage to the flesh of the potatoes existed to a depth of about 5 mm to 25 mm. Potato flesh was otherwise undamaged except under the dark spots. Potatoes which were held at 53° F. before being subjected to a similar dosage of 1-octanol at a similar fogging temperature and fogging rate did not show any evidence of condensation and did not show injury to the potato skin or to its flesh.

This experiment indicates that care must be observed even when treating with an aerosol of 1-octanol at a conventional dosage upon cold potatoes and that treatment of potatoes held at a temperature below about 40° F. may be counter indicated.

Given that other tests have established that octanol and nonanol, for example, are several times more effective at “burning” sprouts that these alcohols may be applied at much lower dosages than, for example, clove oil, with great effectiveness and without damaging the potatoes. Also, given that potatoes are usually stored at temperatures above about 42° F. and that condensation of a higher alcohol upon the potatoes can generally be avoided by adjustment of dosage and aerosolization (fogging) temperatures. Fogging of chemicals at low fogging temperatures tends to give a wet fog, which in the case of higher alcohols could result in damage to treated potatoes.

A significant advantage of mixtures of 1,4-DMN with higher alcohols such as octanol is that there is minimal probability of pitting occurring regardless of dosage, especially when longer sprouts are present. Given that when a large store of potatoes begin to sprout, such sprouting frequently involves nascent sprouts (peeps) to very large sprouts in different locations within a storage unit, this damage-mitigating characteristic of octanol and 1,4-DMN compositions is advantageous.

Mixtures of a higher alcohol and 1,4-DMN may often be used on ware potatoes later in a storage season to “burn” sprouts shortly before the potatoes are shipped to market. It is important in such instances that any odor be very minimal or pleasant. Mixtures of octanol and 1,4-DMN have a moderate odor which is floral in nature. In comparison, both carvone and clove oil, which have been used to “burn” sprouts, have an objectionable odor and in many known instances, packing sheds have shunned their use.

A further advantage of combining 1,4-DMN with a strong desiccating chemical such as a higher alcohol, whether via a pre-mix composition or as a sequential treatment wherein the chemicals are applied so that each is on the potatoes at an effective dosage, is that a rapid “burn” of peeps and sprouts occurs and that pitting is insignificant even over an extended storage period after such treatment.

These combinations of higher alcohols and 1,4-DMN to “burn” existing sprouts and peeps when they appear are very useful, being very effective for this purpose and for treatment of ware potatoes during the latter part of a storage season when it is undesirable to treat with CIPC. Grocers and consumers prefer fresh-pack potatoes without evidence of peeps or sprouts.

A very effective combination, as described hereinabove, comprises a higher alcohol and 1,4-DMN. Compositions in which a higher alcohol is admixed with 1,4-DMN are effective burn agents without a problem with pitting. The solvent effect of 1,4-DMN provides excellent solutions in which decanol and docenol, alcohols which are solid at room temperatures, are the burn agents. Higher alcohols which are liquids at room temperature are also miscible with 1,4-DMN and form effective burn compositions without a pitting problem.

Combinations of 1,4-DMN and various C₆-C₁₂ higher alcohols may be employed as compositions (e.g., a solution, or as separably applied chemicals when octanol and nonanol are the higher alcohols used). Treatment with 1,4-DMN immediately before or after a treatment with a higher alcohol tends to minimize any damage to the flesh of treated potatoes while enhancing the “burn” affect upon existing peeps or sprouts. Also, a first treatment with 1,4-DMN followed later by a treatment with a higher alcohol still has a beneficial effect upon any pitting problem.

Not only are these 1,4-DMN-alcohol compositions useful to treat stored potatoes via fogging techniques, their volatility makes them useful for treatment of potatoes during shipment by application to packages or as a chemical in an aerosol container.

As the above example illustrates, a higher alcohol alone may damage potato flesh of treated potatoes when applied under certain conditions. Also, higher alcohols have caused larger sprouts to be slimy even when smaller sprouts and peeps are effectively desiccated. Such slimy, water sprouts, even though deactivated, would likely lead to rot or decay of affected potatoes in a long-teem storage situation.

The combination of a higher alcohol, especially 1-octanol or 1-nonanol with a small quantity of 1,4-DMN substantially eliminates the flesh damage or slimy sprouts when potatoes are treated with such combination under a wide spectrum of temperatures, humidities, sprout development, and/or storage duration. Given the value of stored potatoes in a large storage facility, any treatment which had the potential to be damaging to the potatoes would be unacceptable.

Higher alcohols, such as 1-octanol and 1-nonanol, are miscible with 1,4-DMN. In particular examples, compositions of higher alcohols in a volumetric ratio of 1:20 to 1:5 with 1,4-DMN (5% to 20% alcohol) have been found to be unexpectedly effective in ameliorated any damaging effect of the alcohol while achieving an enhanced “burn” of existing peeps and sprouts.

The combination of octanol or nonanol with 1,4-DMN may be applied as an aerosol or spray from a liquid composition or each may be applied separately, so long as each one is applied while the other is present in the headspace atmosphere in a storage facility. In such a sequential treatment, it may be desirable to apply the 1,4-DMN first. Preferably, the chemicals are available as vapors and are adsorbed or absorbed by the potatoes, especially by peeps and sprouts.

In particular embodiments, preferred fogging temperatures for 1,4-DMN may be slightly higher than preferred fogging temperatures for higher alcohols, such as 1-octanol. In such instances, 1,4-DMN can be fogged at a desired fogging temperature and then 1-octanol fogged immediately thereafter when the thermofogger has cooled to a preferred temperature range for fogging.

As indicated elsewhere herein, ware potatoes are most marketable when no sprouts or peeps are showing when the potatoes are on a grocers shelve or at a consumer's household. If ware potatoes reach a packing shed with peeps or sprouts showing, they may be safely treated with a 1,4-DMN/octanol composition or sequence. These may be applied separately or as a composition as a very fine mist at a very low dosage. Also, these could be applied as an emulsion in a low concentration with surfactants in a water base. Also, because of the volatility of 1-octanol and 1,4-DMN, only extremely small residues, if any, of either would be on a potato so treated by the time it was consumed. This is in contrast to CIPC, which is often applied in packing sheds, and is considered a potential hazard to humans, or to clove oil which has a very disagreeable odor and causes skin rashes when it is in contact with human skin.

Although 1,4-DMN and higher alcohols such as 1-octanol, 1-nonanol, etc., may be utilized effectively in a wider range of combinations, because of the relative expense of 1,4-DMN, treatments in which the alcohol has a significantly greater presence are generally preferred. It is also especially advantageous that such combinations are very effective at very small dosages and at low concentrations of 1,4-DMN, and that the beneficial effect lasts for an extended period of time.

Combinations of 1,4-DMN and higher alcohols such as 1-octanol and 1-nonanol may be used on seed potatoes since the desiccating effect lasts for a lengthy period of time but does not prevent the eyes from ultimately sprouting. Because 1,4-DMN disrupts apical eye dominance, seed potatoes so treated will tend to produce more potatoes but generally of a smaller and more even size distribution.

Lower alkyl esters of higher alcohols, such as octyl acetate, hexyl acetate, amyl acetate and the like are also effective desiccating agents and may achieve similar results by combinations with DMN (1,4-DMN) similar to combinations of higher alcohols and DMN.

In the discussion of the invention herein and in the appended claims, the term “stored” as applied to potatoes may mean potatoes in transit from one facility to another as well as potatoes located in a storage facility. Also, the words “sprout suppression” is used herein to describe techniques to prevent potato eyes from developing sprouts as well as to techniques for minimizing sprout growth once it has occurred or for eradicating sprouts.

Potatoes treated with 1,4-DMN during storage may be maintained in a dormant-like state in which the potatoes remain well hydrated without developing lengthy sprouts. However, it is an occasional characteristic of potatoes treated with 1,4-DMN that “white peeps” will develop and show for an extended period of time without developing sprouts. Fresh-pack storage houses object to such showing of peeps, as stated above. This is generally not a concern for stored potatoes intended to be processed into French fries, chips, etc. A specific protocol for treatment of stored potatoes intended for the fresh-pack market includes treatment of the potatoes with an effective dosage of 1,4-DMN and then a concurrent or sequential treatment with a higher alcohol (e.g., as a solution of a higher alcohol and DMN, as close sequential treatments, or with a post-DMN treatment with a higher alcohol, such as 1-octanol or 1-nonanol, to burn any “peeps' present during the latter period of the storage season.

Combined treatments with 1,4-DMN and 1-nonanol, or other higher alcohol, such as 1-octanol, without use of CIPC may have further advantages, especially for the fresh-pack market. Potatoes, upon discharge from storage, are washed, inspected for quality and frequently packed according to size (weight) for shipment to market. It is often a concern that the washing of potatoes having any CIPC residue thereon puts CIPC into the wash water discharge, requiring ponding or other remedial water treatment.

It has been observed that the dormancy-like effect produced upon stored potatoes by 1,4-DMN remains, at least to some degree, even as the residue of 1,4-DMN becomes undetectable. Thus, by proper timing of the last treatment of stored potatoes with 1,4-DMN and a subsequent treatment with 1-octanol, 1-nonanol or 1-hexanol, alcohols which are on the GRAS list, both the washed potatoes and any discharged wash water will have no harmful chemicals present. The action of higher alcohols, such as 1-octanol, 1-nonanol and 1-hexanol, on peeps and sprouts is rapid, so that 24 hours after treatment all peeps and sprouts are “burned.”

Although 1-nonanol has a detectable floral odor, it is not as objectionable nor as strong as that of clove oil, which has previously been used as a “burn” agent for potatoes with peeps or sprouts,. In fact, packing houses for fresh-pack potatoes often decline to use clove oil treated potatoes because of its malodorous odor.

What is claimed is:

1. A process for suppressing sprouting of post-harvest potatoes comprising:
treatment of said potatoes with a C₅-C₁₂ carbon alkyl alcohol, aldehyde or ketone compound or lower alkyl esters of said alcohols; and
treatment of said potatoes with a lower alkyl naphthalene compound so that both compounds are in the presence of the stored potatoes at substantially the same time.

2. The process of claim 1, wherein said lower alkyl naphthalene is dimethyl naphthalene.

3. The process of claim 1, wherein said C₅-C₁₂ compound is an isomer of a nonanol (nonyl alcohol) or a lower alkyl ester thereof.

4. The process of claim 3 wherein said isomer is 1-nonanol

5. The process of claim 1, wherein said C₅-C₁₂ compound is 1-hexanol.

6. The process of claim 2, wherein said dimethyl naphthalene is 1,4-DMN.

7. The process of claim 1, wherein said C₅-C₁₂ compound is 1-octanol.

8. The process of claim 1, wherein said treatment of potatoes with a C₅-C₁₂ is made after treatment of said potatoes with a lower alkyl naphthalene.

9. The process of claim 1, wherein said treatments are made in any order sequentially to one another.

10. A composition for treatment of post-harvest potatoes to suppress sprouting comprising:
a C₅-C₁₂ carbon compound selected from the group consisting of alkyl and alkenyl alcohols, aldehydes and ketones; and
a lower alkyl naphthalene.

11. The composition of claim 10, wherein said lower alkyl naphthalene is present as the major component.

12. The composition of claim 10, wherein the C₆-C₁₂ compound is 1-nonanol, 1-hexanol, 1-octanol, or 1-decanol and the alkyl naphthalene is 1,4-DMN.

13. The composition of claim 12, wherein the volume ratio of 1-nonanol, 1-hexanol, 1-octanol, or 1-decanol to the lower alkyl naphthalene 1,4-DMN is from about 20:1 to about 1:20.

14. The composition of claim 13, wherein the volume ratio is from about 10:1 to about 1:10.

15. A method of desiccating existing sprouts on post-harvest potatoes comprising applying a thermofogged aerosol of a C₅-C₁₂ alkyl alcohol and lower alkyl naphthalene for a predetermined period of time to provide a concentration of said aerosol in the atmosphere surrounding said potatoes effective to desiccate any sprouts and/or peeps present upon said potatoes.

16. The method of claim 15 wherein said thermofogged aerosol is produced in a hot gas stream at a temperature of less than about 550° F.

17. The method of claim 15 wherein said thermofogged aerosol is introduced to said stored potatoes over a time period of less than about six hours.

18. The method of claim 15 wherein said thermofogged aerosol provides said higher alcohol at a dosage of less than about 50 ppm based upon the total weight of said stored potatoes.

19. The method of claim 15 wherein said lower alkyl naphthalene is 1,4-DMN.

20. The method of claim 19 wherein said alcohol is 1-nonanol, 1-hexanol, 1-octanol, or 1-decanol.

21. The method of claim 20 wherein the volumetric ratio of 1,4-DMN to 1-nonanol 1-hexanol, 1-octanol or 1-decanol is from about 1:10 to about 10:1.

22. The process of claim 15 wherein said potatoes are in a storage facility and are exhibiting peeps and/or sprouts.

23. The method of claim 15 wherein said treatment comprises a first treatment with a lower alkyl naphthalene immediately before said second treatment with a C₅-C₁₂ carbon alkyl alcohol, aldehydes or ketone or lower alkyl esters of said alcohols.

24. The method of claim 23 wherein a concentration of a lower alkyl naphthalene is present in the atmosphere surrounding said potatoes at the time of second treatment.

25. The method of claim 15 wherein said alcohol is a C₈-C₁₀ alcohol.

26. The method of claim 15 wherein said alcohol is thermofogged at a temperature approximating its boiling point.

27. A method of treating post-harvest tubers with a composition of a C₅-C₁₀ alkyl alcohol and 1,4-DMN by thermofogging said composition at a temperature at about 350° F. to about 550° F.
